(19) United States
(12) Patent Application Publication
(10) Pub. No.: US 2021/0200500 A1
(43) Pub. Date: Jul. 1, 2021

(54) TELEPRESENCE DEVICE ACTION SELECTION

(71) Applicant: HEWLETT-PACKARD DEVELOPMENT COMPANY, L.P., Spring, TX (US)

(72) Inventors: Harold MERKEL, Houston, TX (US); Will ALLEN, Corvallis, OR (US)

(73) Assignee: HEWLETT-PACKARD DEVELOPMENT COMPANY, L.P., Spring, TX (US)

(21) Appl. No.: 16/076,871

(22) PCT Filed: Apr. 13, 2017
(86) PCT No.: PCT/US2017/027351

§ 371 Date: Aug. 9, 2018

(51) Int. Cl. G06F 3/14; H04N 7/14; G06K 9/00

(52) U.S. Cl. CPC G06F 3/1454; G06K 9/00281; H04N 7/147

(57) ABSTRACT

Examples disclosed herein related to selecting a telepresence device action. In one implementation, an electronic device determines a non-verbal characteristic of a communication of a first user intended for a second user at a remote location. The electronic device may determine a characteristic of the second user and select a delivery action based on a translation of the non-verbal characteristic to the second user based on the characteristic of the second user. The electronic device may transmit information about the selected delivery action to an electronic device to cause the electronic device to perform the selected action to provide the communication to the second user.

### BACKGROUND

A telepresence device may be used for remote meetings. For example, a user may control a telepresence robot that attends a meeting in a remote location from the user and represents the user in the remote location. The telepresence robot may include a display that shows the user and/or content presented by the user.

### BRIEF DESCRIPTION OF THE DRAWINGS

The drawings describe example embodiments. The following detailed description references the drawings, wherein:

FIGS. 1A, 1B, and 1C are block diagrams illustrating examples of computing systems to select an action of a telepresence device.

FIG. 2 is a flow chart illustrating one example of a method to select an action of a telepresence device.

FIG. 3 is a diagram illustrating one example of selecting an action of a telepresence device.

FIG. 4 is a diagram illustrating one example of selecting different actions for different telepresence devices.

FIG. 5 is a diagram illustrating one example of selecting an action of a telepresence device.

### DETAILED DESCRIPTION

In one implementation, an electronic device selects an action for a telepresence device to perform. For example, the electronic device may select an action to translate a non-linguistic aspect of a communication from a first remote user to a second remote user based on a characteristic of the second user. The electronic device may transmit information to cause a telepresence robot to perform the selected action to deliver the communication to the second user. Translating a communication characteristic based on the presenter and audience may result in improved communication between different cultures, improved expression of emotion, and/or increased acceptance of telepresence devices.

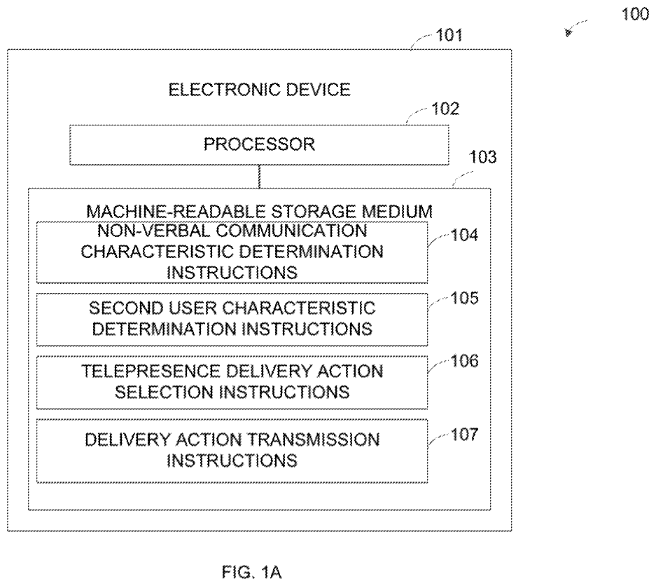

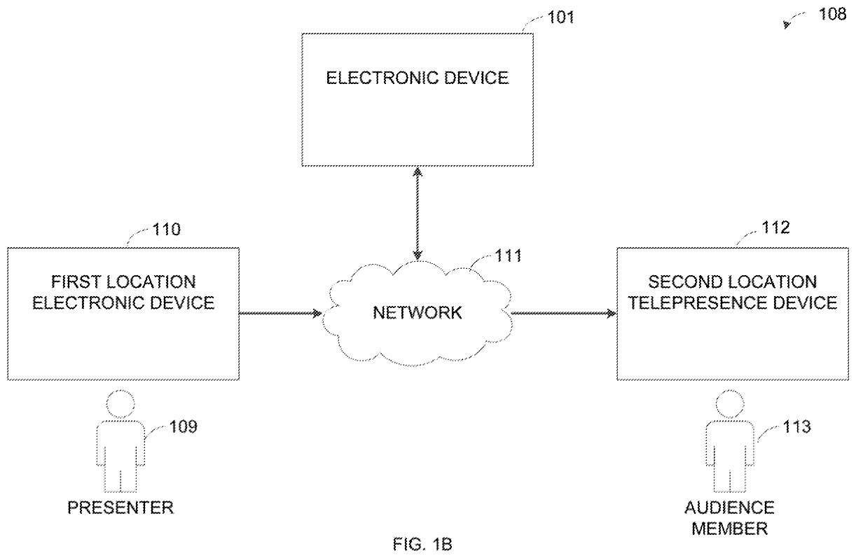

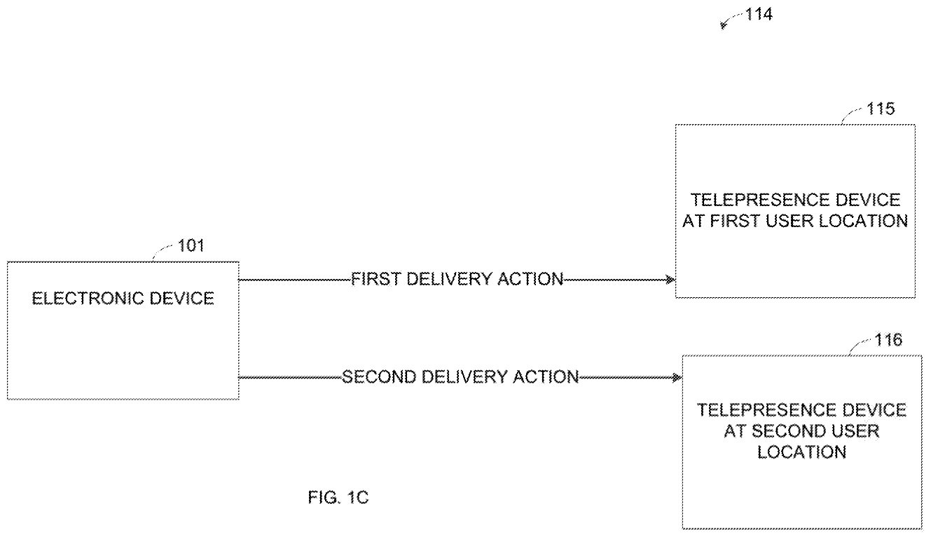

FIGS. 1A, 1B, and 1C are diagrams illustrating examples of computing systems to select an action of a telepresence device. FIG. 1A is a diagram illustrating a computing system 100 including an electronic device 101. The electronic device 101 may receive information about a user communication and select an action for a telepresence device to present the communication based on the communication and information about the audience. For example, the electronic device 101 may provide a cloud solution for communicating between a first device at a first location and a second device at a second location. The electronic device 101 may be part of a collaboration device for capturing information about the communication and/or part of the telepresence device to perform the selected action. The electronic device 101 includes a processor 102 and a machine-readable storage medium 103. The processor 102 and machine-readable storage medium 103 may be included in the same or different device enclosures.

The processor 102 may be a central processing unit (CPU), a semiconductor-based microprocessor, or any other device suitable for retrieval and execution of instructions. As an alternative or in addition to fetching, decoding, and executing instructions, the processor 102 may include one or more integrated circuits (ICs) or other electronic circuits that comprise a plurality of electronic components for performing the functionality described below. The functionality described below may be performed by multiple processors.

The processor 102 may communicate with the machine-readable storage medium 103. The machine-readable storage medium 103 may be any suitable machine readable medium, such as an electronic, magnetic, optical, or other physical storage device that stores executable instructions or other data (e.g., a hard disk drive, random access memory, flash memory, etc.). The machine-readable storage medium 103 may be, for example, a computer readable non-transitory medium. The machine-readable storage medium 103 may include non-verbal communication characteristic determination instructions 104, second user characteristic determination instructions 105, telepresence delivery action selection instructions 106, and delivery action transmission instructions 107.

The non-verbal communication characteristic determination instructions 104 may include instructions to determine a non-verbal characteristic of a communication of a first user, such as a presenter. For example, information about the communication may be captured by a camera, microphone, video camera, and/or biometric monitor at a first location where the first user is located. The electronic device 101 may determine the non-verbal characteristic based on information received from a sensor. The non-verbal characteristic may be related to an emotion, gesture, and/or intent of the communication. The non-verbal communication characteristic may be determined in any suitable manner, such as based on facial analysis, voice volume, gesture type, and other information. The non-verbal communication characteristic may be determined based on accessing a storage of information of weighted features associated with a characteristic. In one implementation, the non-verbal communication characteristic is determined based on a machine-learning method.

The second user characteristic determination instructions 105 may include instructions to determine a characteristic of a second user to receive the communication from a telepresence device. For example, the determination may be related to emotional state, attentiveness, demographics, and/or culture of the second user. The characteristic may be determined based on stored information related to the user, such as information related to the particular second user or to a type of user category including the second user. The characteristic may be determined based on audio, biometric, image and/or video information related to the second user. In some implementations, the characteristic is determined based on a reaction of the second user to a previous communication from the first user or another user.

The telepresence delivery action selection instructions 106 may include instructions to select a delivery action for the telepresence electronic device based on a translation of the non-verbal characteristic based on the second characteristic. For example, the action may involve an update to a display of a telepresence robot, updating audio volume or tone from a speaker associated with the telepresence robot, and/or moving an appendage of the telepresence robot. The delivery action may be selected in any suitable manner, such as based on accessing a storage associating a delivery action with the communication feature and the second user characteristic. For example, a storage may include a look up table correlating emotions and expressions of a presenter to emotions and expressions of an audience member. The table may be related to specific participants or characteristic of participants, such as based on age and location. As an example, an expression of anxiety may by a presenter may be translated into a different expression for the particular audience member. For example, a high five from a presenter may be associated with both a fist pump and a verbal explanation. In one implementation, the translation is not 1:1. For example, there may be multiple expressions of affirmation understandable by the audience member, and the processor 101 may combine a subset of expressions or randomly select from the set of expressions to create a more human-like and natural communication style. As an example, multiple actions may be selected, such as where a telepresence robot winks an eye on a head display and waves a robotic arm.

In one implementation, the action is selected based on characteristics of multiple users. For example, the second user may be an audience member at a remote site where the telepresence robot represents the first user in a room of twenty participants. The electronic device 101 may select the delivery action based on aggregate user audience information, such as based on weighting characteristic based on the number of the participants exhibiting the characteristic.

The delivery action transmission instructions 107 may include instructions to transmit information about the selected delivery action to the telepresence device to cause the second telepresence device to perform the selected action at the site of the second user.

FIG. 1B is a diagram illustrating one example of a computing system to select an action of a telepresence device. For example, the computing system 108 includes a first location electronic device 110 and a second location telepresence device 112. The first location electronic device 110 may be any suitable electronic device to capture a communication from a presenter 109. For example, the first location electronic device 108 may receive typed, verbal, biometric, or gesture input from the presenter 109. The first location electronic device 108 may capture a video and/or image of the presenter 109.

The second location telepresence device 112 may provide information from the presenter 109 to be communicated to the audience member 113. For example, the second location telepresence device 112 may be a telepresence robot that communicates with the audience member 113. In one implementation the second location telepresence device 112 captures information about the second location and/or audience member 113 to communicate back to the presenter 109.

The electronic device 101 from FIG. 1 communicates between the first location electronic device 108 and the second location telepresence device 112 via a network 111. The electronic device 101 may select an action for the second location telepresence device 112 based on a non-verbal feature of a communication of the presenter 109 captured by the first location electronic device 108 and based on a characteristic of the audience member 113.

In one implementation, the computing system 108 is used for a dialogue between the presenter 109 and the audience member 113 such that the audience member 113 becomes a presenter to the presenter 109.

FIG. 1C is a diagram illustrating one example of a computing system to select an action of a telepresence device. The computing system 114 includes the electronic device 101 from FIG. 1. For example, the electronic device 101 may translate information related to a non-verbal aspect of a communication from a presenter to a first user at a first location and a second user at a second location. The computing system 114 includes a telepresence device at a first location 115 and a telepresence device at a second location 116. The electronic device 101 may select a delivery action based on a characteristic of a first user at the first location that is different from a characteristic of a second user at the second location. For example, the electronic device 101 may translate the same communication from a presenter using a first delivery action of a telepresence device at a first location 115 and a second delivery action of a telepresence device at a second location 116. As an example, the first delivery action may involve causing a telepresence robot to raise robotic arms, and the second delivery action may involve causing a telepresence robot to smile.

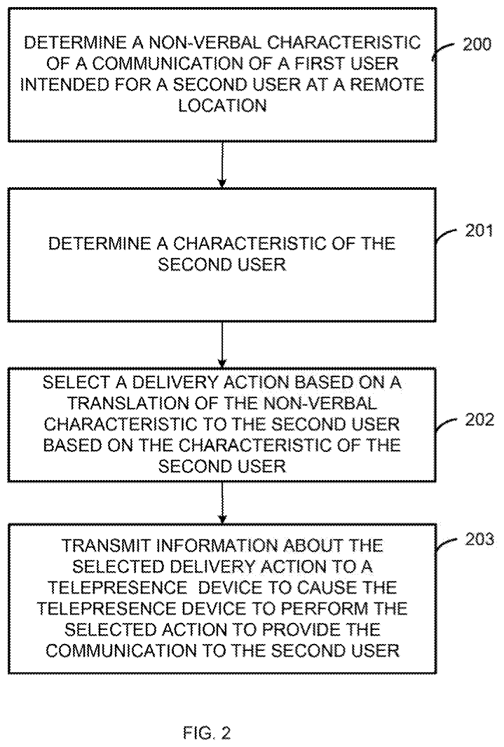

FIG. 2 is a flow chart illustrating one example of a method to select an action of a telepresence device. For example, a processor may select the action based on a non-verbal feature of a communication from a first user and based on a characteristic of a second user to receive the communication. The action may be selected to translate an emotion or other aspect of the communication. In some cases, the action may be selected to translate between different cultures of the two users, such as cultural attributes based on age or location. The method may be implemented, for example, by the electronic device 101 of FIG. 1.

Beginning at 200, a processor determines a non-verbal characteristic of a communication of a first user intended for a second user at a remote location. The non-verbal characteristic may be any suitable non-verbal characteristic, such as related to an intent, emotion, or other information in addition to the words associated with the communication. In one implementation, the processor determines the non-verbal characteristic based on an emotional state of the first user.

The processor may determine the non-verbal characteristic in any suitable manner. For example, the processor may receive sensor data from a location where the first user provides the communication. The sensor data may include video, audio, biometric, gesture, or other data types. In one implementation, the processor determines a non-verbal characteristic based on multiple communications and/or actions. The processor may determine the non-verbal characteristic from the sensor data based on a machine-learning method or database comparison of sensor data to characteristics. In one implementation, the processor measures landmark facial features of the first user and compares them to templates associated with emotions, such as ranges associated with a smile or a frown. In one implementation, the processor uses a machine-learning method, such as based on a system trained with tagged images of emotional states. In one implementation, an overall emotion or response is based on an amount of time the user is associated with different classifications, such as the amount of time gazing at a presentation device or the amount of time spent smiling. The processor may determine whether a person is smiling based on machine vision methods that detect and track landmark features that define facial features, such as eyes, eyebrows, nose, and mouth. The processor may determine an emotional expression based on the position and other information associated with the landmark features.

Continuing to 201, a processor determines a characteristic of the second user. The processor may determine the characteristic based on any suitable information, such as based on sensor data related to a user at a remote location from the first user. For example, the information may include movement analysis, eye gaze direction, eye contact, head movement, facial expression, eye expression, attentiveness, biological information, and voice characteristics. The information may be determined based on a response of the second user to a previous communication from the first user or from another user. The processor may determine any suitable information about the second user, such as cultural, demographic, professional, and emotional information. As an example, the percentage of gaze time at a device not associated with the presentation may be determined and used to indicate lower meeting engagement.

Continuing to 202, a processor selects a delivery action based on a translation of the non-verbal characteristic to the second user based on the characteristic of the second user. The selected delivery action may be any suitable delivery action. For example, the selected delivery action may relate to movement, gesture, vocal tone, vocal loudness, eye gaze, and/or laughter. The selected delivery action may involve a movement of a robotic body part of the second telepresence device, an audio volume selection for the second telepresence device, a physical location movement of the second telepresence device, a change to a displayed image associated with the second telepresence device, and/or a movement of a display of the second telepresence device.

In one implementation, the processor determines a non-verbal characteristic and adjusts it based on user input. For example, the characteristic may be altered to mask, escalate, or diminish a characteristics. The delivery action may be selected to adjust the characteristic, such as to show more or less or a different emotion.

The delivery action may be selected in any suitable manner. In one implementation, the processor accesses stored information about translating a non-verbal characteristic.

In one implementation, the processor selects the delivery action based on device capabilities of the second telepresence device. For example, the type of output, movement speed capability, movement type capabilities, and other information about the device may be considered. As an example, the processor may select a type of delivery action, and the individual delivery action may be selected based on a method for implementing the delivery action type associated with the set of device capabilities. In one implementation, the processor accesses prioritization information about a delivery action type and selects the action of the highest priority that the second telepresence device is determined capable of implementing.

Continuing to 203, a processor transmits information about the selected delivery action to a telepresence device to cause the telepresence device to perform the selected action to provide the communication to the second user. For example, the second telepresence device may deliver the communication with the selected delivery action, such as where a telepresence robot provides an audio communication from the first user while moving its arms to signify excitement. The telepresence device may be any suitable telepresence device. For example, the telepresence device may be a robot that represents the first user, such as with a head display showing the face of the first user. The telepresence device may be a laptop, desktop computing device, mobile device, and/or collaboration display.

In one implementation, the processor receives information about a response of the second user, such as a video, audio, or biometric response, and uses the response for subsequent translations to the second user from the first user or from other users. For example, if a type of delivery action is determined to make the second user anxious or inattentive, the delivery action may be weighted downward such that it is used less often when communicating with the second user.

In one implementation, the processor selects a delivery action for a telepresence device at the first location. The telepresence device may be the device sensing information about the first communication from the first or a separate device. The processor may receive a response or other communication from the second user and select a second delivery action used to deliver the communication from the second user to the first user.

In one implementation, the processor may translate the non-verbal communication characteristic differently to a third user. For example, the processor may select a second delivery action based on a characteristic of a third user and transmit information about the second delivery action to the third telepresence device to cause the third telepresence device to perform the second delivery action when providing the communication to the third user.

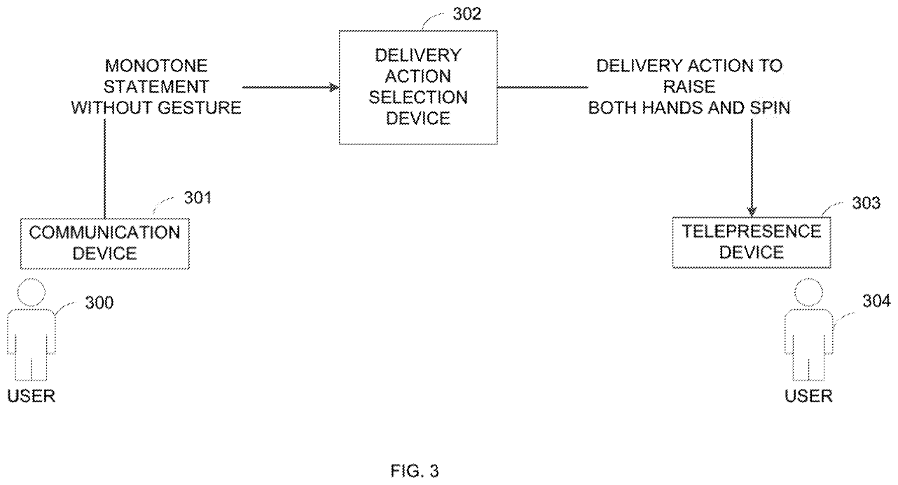

FIG. 3 is a diagram illustrating one example of selecting an action of a telepresence device. FIG. 3 includes a user 300, communication device 301, delivery action selection device 302, a telepresence device 303, and a user 304. The user 300 may communicate with the user 304 via the telepresence device 303. For example, the telepresence device 303 may be a robot or other device to represent the user 300. The delivery action selection device 302 may be the electronic device 101 of FIG. 1.

As an example, first, the user 300 communicates with the communication device 301 providing a monotone type communication in an unexcited manner, such as a monotone statement without using any hand gestures. The communication device 301 transmits information about the communication to the delivery action selection device 302. For example, the communication device 301 may include or receive information from a camera, video camera, or other sensing device. The delivery action selection device 302 selects a delivery action for the telepresence device 303 based on the received information and based on a characteristic of the user 304. For example, the delivery action selection device 302 may determine based on an image of the user 304 or based on stored information related to the user 304 that the user 304 is between the ages of 3 and 5. The delivery action selection device 302 may select a delivery action involving having the telepresence device 303 to spin and raise both hands when delivering the communication to the user 304. For example, the action may be selected based on the intent of the user 300 to convey the message and the type of communication that a 3-5 year old may be more receptive to. The delivery action selection device 302 may transmit information about the selection to the telepresence device 303. The telepresence device 303 may perform the selected action to the user 304.

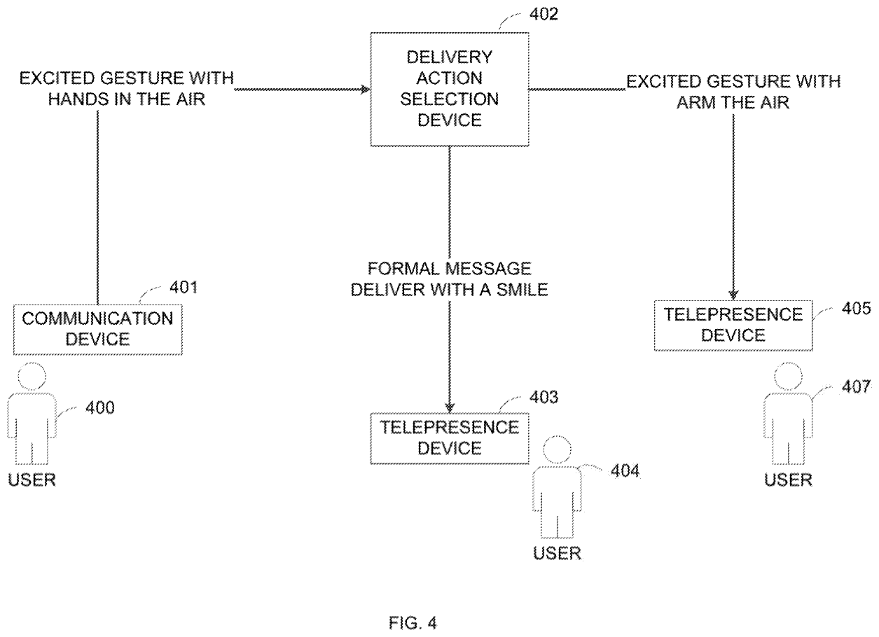

FIG. 4 is a diagram illustrating one example of selecting different actions for different telepresence devices. FIG. 4 includes a user 400 that communicates simultaneously with remote users 404 and 407 via telepresence devices 403 and 405, respectively. A communication device 401 may capture information about a communication from user 400 and transmit the information to delivery action selection device 402. The delivery action selection device 402 may select different actions for the telepresence devices 403 and 405, such as based on differences in the associated users and/or differences in the device technology capabilities. For example the delivery action selection device 402 may implement the method of FIG. 2.

First, the user 400 communicates with an excited hand gesture that is captured by the communication device 401. Information about the action may be transmitted to the delivery action selection device 402. The delivery action selection device 402 may select an action for the telepresence device 405 to perform for the user 407. For example, the telepresence device 405 may be a telepresence robot with robotic arms without hands. The delivery action selection device 402 may select an action involving arm movement to display excitement that portrays a similar emotion to the hand gesture of the user 400. The delivery action selection device 402 may transmit information about the selected action to the telepresence device 405, and the telepresence device 405 may perform the selected action for the user 407.

The delivery action selection device 402 may select a different delivery action for the telepresence device 403 based on characteristics of the telepresence device 403 and/or user 404. For example, the delivery action selection device 402 may determine that the user 404 is in a location associated with a more formal culture. The delivery action selection device may select an action for the telepresence device 403 to portray a smile to represent the excitement of user 400.

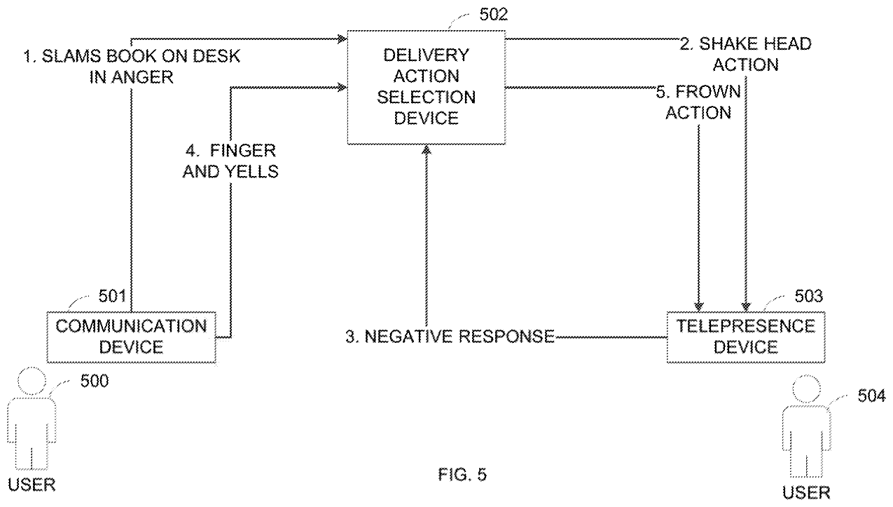

FIG. 5 is a diagram illustrating one example of selecting an action of a telepresence device based on a previous response of a user to a previous action by a telepresence device. FIG. 5 includes a user 500, a communication device 501 to capture a communication of a user 500 intended for a remote user 504, a delivery action selection device 502 to select an action to translate the action of the user 500 to a telepresence device 503. For example, the delivery action selection device 502 may implement the method of FIG. 2. The telepresence device 503 may perform the selected action to communicate with the user 504. The delivery action selection device 502 may select the action based on a previous response of the user. For example, the delivery action selection device 502 may operate in a feedback loop to take advantage of previous response information.

As an example, first, the user 500 communicates with the communication device 501. For example, the user 500 may slam a book on a desk in anger when communicating with the user 504. The communication device 501 may capture a video of the communication and transmit the information to the delivery action selection device 502. The delivery action selection device 502 may translate the emotion of user 500 to an action involving the telepresence device 503 shaking a robotic head. The different action than the user 500 may be selected based on device capabilities and/or characteristics of the user 504. For example, the delivery action selection device 502 may access stored information that indicates that an angry communication should be masked one level for the particular user 504 to increase likelihood of continued engagement from user 504.

The telepresence device 503 or another device for capturing information about user 504 may capture information about the response of user 504 to the communication. The user 504 may respond negatively, and the telepresence device 503 may transmit information about the negative response to the delivery action selection device 502.

The user 500 may communicate again with the user 504, and the communication may be captured by capture device 501. The communication may involve an angry communication from the user 500 where the user 500 points his finger and yells. The communication device 501 may transmit information about the communication to the delivery action selection device 502. The delivery action selection device 502 may select an action for the telepresence device 503 based on the previous response information of the user 504. For example, the delivery action selection device 502 may determine to mask the angry emotion another level due to the previous response. The delivery action selection device 502 may select a frowning action, such as by displaying a frown on a display acting as a head of a telepresence robot. The delivery action selection device 502 may transmit information about the selected action to the telepresence device 503 such that the telepresence device 503 may perform the action for the user 504. Selecting an action for a telepresence device based on a characteristic of a communication and a characteristic of a recipient may result in better communication between remote collaborators.

1. A computing system, comprising:
a processor to:
determine a non-verbal characteristic of a communication of a first user to a first device;
determine a characteristic of a second user remote from the first user to receive the communication from a telepresence device;
select a delivery action for the telepresence device based on a translation of the non-verbal characteristic to the second user based on the characteristic of the second user; and
transmit information about the selected delivery action to the telepresence device to cause the telepresence device to perform the selected action.

2. The computing system of claim 1, wherein selecting the delivery action comprises selecting the delivery action based on device capabilities of the telepresence device.

3. The computing system of claim 1, wherein determining the characteristic of the second user comprises determining the characteristic based on at least one of related to the second user: movement analysis, eye gaze direction, eye contact, head movement, facial expression, eye expression, attentiveness, biological information, and voice characteristics.

4. The computing system of claim 1, wherein the processor is further to select the delivery action to mask or escalating the non-verbal characteristic.

5. The computing system of claim 1, wherein the selected delivery action relates to at least one of movement, gesture, vocal tone, vocal loudness, eye gaze, and laughter.

6. The computing system of claim 1, wherein the processor is further to:
determine a characteristic of a third user to receive the communication from a second telepresence device;
select a second delivery action for the second telepresence device based on a translation of the non-verbal characteristic to the third user based on the characteristic of the third user; and
transmit information about the selected second delivery action to the second telepresence device to cause the second telepresence device to perform the second delivery action.

7. The computing system of claim 1, wherein the processor is further to receive a response from the second user and select a delivery action of the first device to deliver the response to the first user.

8. A method, comprising:
determining, by an electronic device, a non-verbal characteristic of a communication of a first user intended for a second user at a remote location;
determining a characteristic of the second user;
selecting a delivery action based on a translation of the non-verbal characteristic to the second user based on the characteristic of the second user; and
transmitting information about the selected delivery action to an electronic device to cause the electronic device to perform the selected action to provide the communication to the second user.

9. The method of claim 8, further comprising:
determining a response of the second user; and
utilizing the determined response information to translate a subsequent communication to the second user.

10. The method of claim 8, wherein determining a characteristic of the second user comprises determining at least one of: cultural, demographic, professional and emotional information.

11. The method of claim 8, wherein determining the non-verbal characteristic comprises determining an emotional state of the first user.

12. The method of claim 8, wherein the delivery action comprises at least one of: a movement of a robotic body part of the second telepresence device, an audio volume selection for the second telepresence device, a physical location movement of the second telepresence device, a movement of a display of the second telepresence device, and a change to an image on a display of the second telepresence device.

13. A machine-readable non-transitory storage medium comprising instructions executable by a processor to:
select an action to translate a non-linguistic aspect of a communication from a first remote user to a second remote user based on a characteristic of the second user; and
cause a telepresence robot to perform the selected action to deliver the communication to the second user.

14. The machine-readable non-transitory storage medium of claim 13, wherein the non-linguistic aspect comprises an emotion associated with the communication.

15. The machine-readable non-transitory storage medium of claim 13, further comprising instructions to determine the characteristic of the second user based on an emotional response associated with an image of facial features of the second user.
